(19) United States
(12) Patent Application Publication
(10) Pub. No.: US 2018/0360165 A1
(43) Pub. Date: Dec. 20, 2018

(54) Shoe with Smart Displaying Set

(71) Applicant: Yiming QIU, Chino Hills, CA (US)

(72) Inventor: Yiming QIU, Chino Hills, CA (US)

(21) Appl. No.: 15/624,472

(22) Filed: Jun. 15, 2017

(51) Int. Cl. A43B 23/24; G09G 3/20; A43B 3/00; A43B 5/00

(52) U.S. Cl. CPC A43B 23/24; G09G 3/2096; G09G 3/32; A43B 5/00; G09G 2370/16; A43B 3/001

(57) ABSTRACT

A shoe includes a sole, an upper member provided on the sole, and a smart displaying set for being controlled by a control unit. The smart displaying set includes a display mount which includes an accommodating seat configured from a predetermined flexible and elastic material. The display unit includes a main casing, a display screen, a control circuitry and a wireless transceiver. The display mount is attached on the shoe, while the display unit is detachably received in the accommodating seat and secured in position by at least one peripheral mounting rim of the display mount, so that a user is capable of detachably attaching the display unit on the display mount and select visual content to be displayed by the display screen through controlling the control unit.

### BACKGROUND OF THE PRESENT INVENTION

### Field of Invention

The present invention relates to a shoe, and more particularly to a wirelessly controlled smart displaying set which may be attached on a wide variety of personal items such as a shoe for displaying desirable content.

### Description of Related Arts

A conventional personal accessory for displaying purpose may take a wide variety of forms. For example, a cellular phone may have a display screen for displaying visual content. Moreover, a smart watch may comprise a relatively smaller display screen for displaying information which may otherwise be shown on the cellular phone.

A disadvantage of these conventional displaying devices is that none of the existing displaying device may be securely attached on a user's clothing or shoes. For example, the smart watches described above cannot be attached on the user's hat, shoes, or sweater. There exist conventional shoes in which some sorts of LED illuminators may be embedded in or provided on the users' shoes. However, such LED illuminators can only generate illumination and do not include a display screen and cannot be wirelessly controlled by a user to display desirable visual content.

Another disadvantage in association with LED illuminators is that the battery used for driving the LED illuminators are usually embedded in the shoes. Thus, the wearer of the shoes do not have access to the battery and when the LED illuminators run out of battery, the LED illuminators will not operate again.

As a result, there is a need to provide some sorts of displaying devices which may be attached on a user's personal accessory for displaying desirable and customized visual content.

### SUMMARY OF THE PRESENT INVENTION

Certain variations of the present invention provide a wirelessly controlled smart displaying set which may be attached on a wide variety of personal items such as a shoe for displaying desirable visual content.

Certain variations of the present invention provide a wirelessly controlled smart displaying set which may comprise a display mount and a display unit detachably mounting in the display mount, wherein the display mount may be detachably attached on a wide variety of personal accessories (such as a shoe, a hat or a clothing article etc.) so as to allow a user to impart a customized and visual display on his desirable personal accessories.

Certain variations of the present invention provide a wirelessly controlled smart displaying set comprising a display unit which may be wirelessly controlled by a mobile device such as a user's smartphone so that a desirable and customized visual display content may be transferred from the mobile device to the display unit which may then display the visual content in a customized fashion.

Certain variations of the present invention provide a wirelessly controlled smart displaying set which may comprise a display mount and a display unit detachably mounting in the display mount, wherein a user may conveniently and easily detach the display unit from the display mount for regular maintenance.

In one aspect of the present invention, it provides a shoe, comprising:

a sole;

an upper member provided on the sole; and

a smart displaying set for being controlled by a control unit, comprising:

a display mount which comprises an accommodating seat configured from a predetermined flexible and elastic material, the accommodating seat having a receiving cavity and a peripheral mounting rim; and

a display unit, which comprises:

a main casing sized and shaped to correspond to the receiving cavity;

a display screen supported by the main casing and visually exposed to an exterior of the display mount;

a control circuitry received in the main casing; and

a wireless transceiver received in the main casing and electrically connected to the control circuitry, the wireless transceiver being wirelessly connected to the control unit, wherein the control circuitry is arranged to drive the display screen to display customized visual content according to signals received from the control unit,

wherein the display mount is attached on the shoe, while the display unit is detachably received in the accommodating seat and secured in position by the peripheral mounting rim of the display mount, so that a user is capable of detachably attaching the display unit on the display mount and select visual content to be displayed by the display screen through controlling the control unit.

In another aspect of the present invention, it provides a smart displaying set for being controlled by a control unit, comprising:

a display mount which comprises an accommodating seat configured from a predetermined flexible and elastic material, the accommodating seat having a receiving cavity and a peripheral mounting rim; and

a display unit, which comprises:

a main casing sized and shaped to correspond to the receiving cavity;

a display screen supported by the main casing and visually exposed to an exterior of the display mount;

a control circuitry received in the main casing; and

a wireless transceiver received in the main casing and electrically connected to the control circuitry, the wireless transceiver being wirelessly connected to the control unit, wherein the control circuitry is arranged to drive the display screen to display customized visual content according to signals received from the control unit,

wherein the display mount is attached on a personal accessory, while the display unit is detachably received in the accommodating seat and secured in position by the peripheral mounting rim of the display mount, so that a user is capable of detachably attaching the display unit on the display mount and select visual content to be displayed by the display screen through controlling the control unit.

This summary presented above is provided merely to introduce certain concepts and not to identify any key or essential features of the claimed subject matter.

### BRIEF DESCRIPTION OF THE DRAWINGS

FIG. 1 is a perspective view of a smart displaying set according to a preferred embodiment of the present invention.

FIG. 2 is an exploded perspective view of the smart displaying set according to the preferred embodiment of the present invention.

FIG. 3 is a sectional side view of an accommodating seat according to the preferred embodiment of the present invention.

FIG. 4 is a block diagram of the internal structure of the display unit of the smart displaying set according to the preferred embodiment of the present invention.

FIG. 5A to FIG. 5D are schematic diagrams of the smart displaying set according to the preferred embodiment of the present invention.

FIG. 6 is an exploded perspective view of the smart displaying set according to the preferred embodiment of the present invention, illustrating that the display mount may be configured to have another cross sectional shape.

FIG. 7 is a first alternative mode of the present invention illustrating that the smart displaying set may be provided on a T-shirt.

FIG. 8 is a second alternative mode of the present invention illustrating that the smart displaying set may be provided on a hat.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

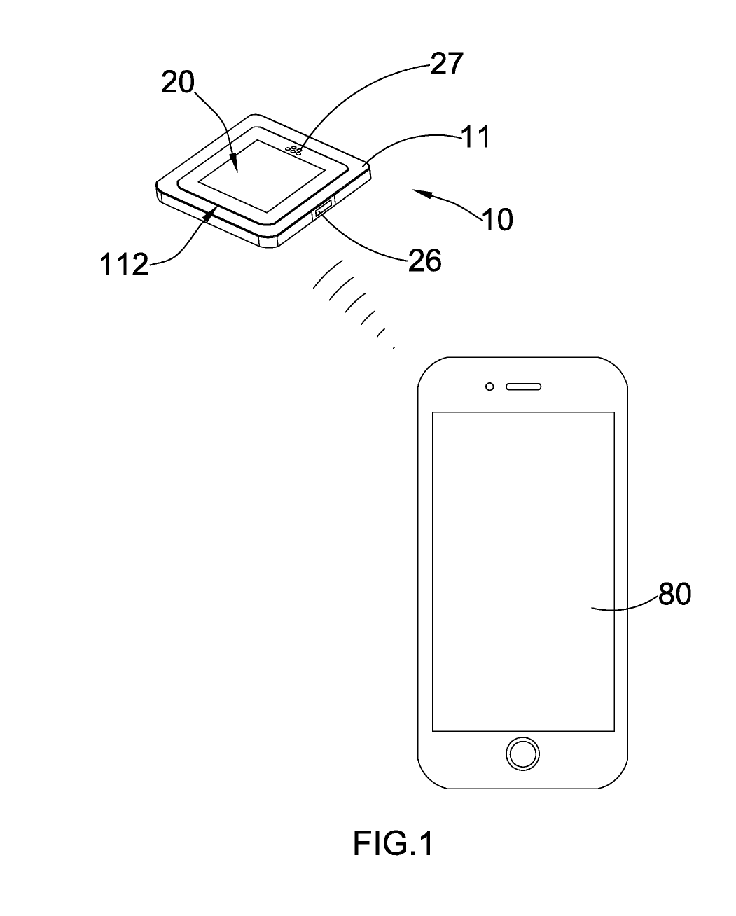

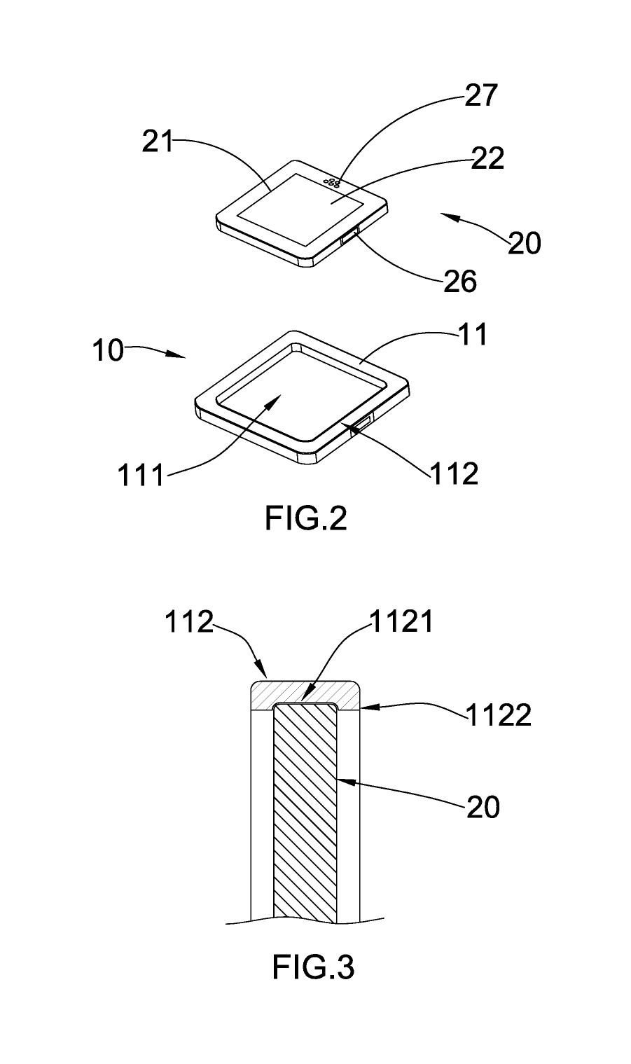

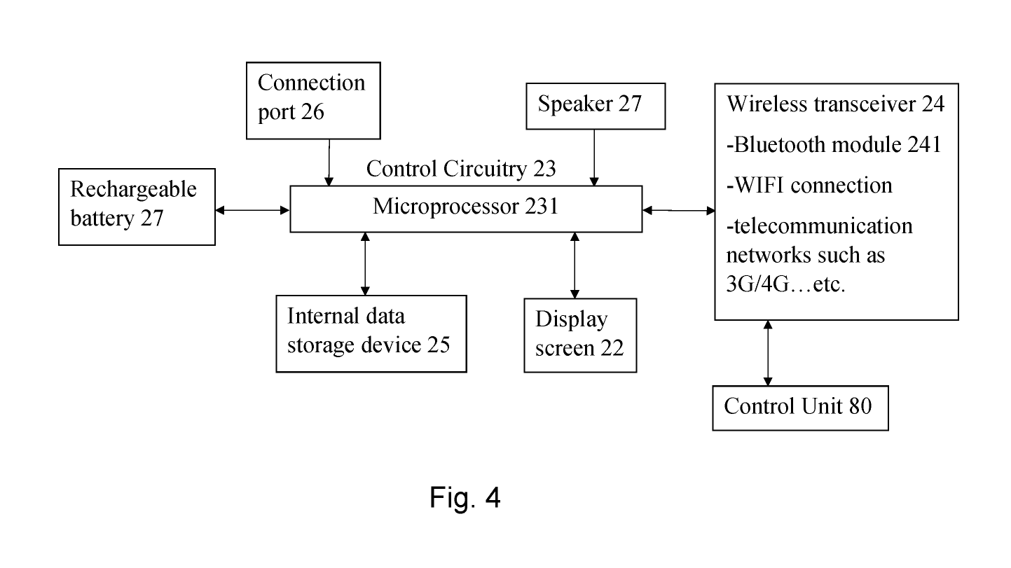

Referring to FIGS. 1 to 4, FIG. 5A to FIG. 5D, and FIG. 6 of the drawings, a smart displaying set according a preferred embodiment of the present invention is illustrated. The smart displaying set is for being controlled by a control unit 80 such as a smartphone. Broadly, the smart displaying set may comprise a display mount 10, and a display unit 20.

The display mount 10 may comprise an accommodating seat 11 configured from a predetermined flexible and elastic material. The accommodating seat 11 may have a receiving cavity 111 and a peripheral mounting rim 112.

The display unit 20 may comprise a main casing 21, a display screen 22, a control circuitry 23 and a wireless transceiver 24. The main casing 21 may be sized and shaped to correspond to the receiving cavity 111 of the accommodating seat 11.

The display screen 22 may be supported by the main casing 21 and visually exposed to an exterior of the display mount 10. The control circuitry 23 may be received in the main casing 21.

The wireless transceiver 24 may be received in the main casing 21 and may be electrically connected to the control circuitry 23. Moreover, the wireless transceiver 24 may be wirelessly connected to the control unit 80, wherein the control circuitry 23 may drive the display screen 22 to display customized visual content according to signals received from the control unit 80.

The display mount 10 may be attached on a personal accessory 90, while the display unit 20 may be detachably received in the accommodating seat 11 and secured in position by the peripheral mounting rim 112 of the display mount 10, so that a user is capable of detachably attaching the display unit 20 on the display mount 10 and select visual content to be displayed by the display screen 22 through controlling and operating the control unit 80.

According to the preferred embodiment of the present invention, the smart displaying set may be wirelessly connected and controlled by the control unit 80. The control unit 80 may be a user's mobile control device, such as a smartphone. Other devices are also possible, such as a tablet computer, or a conventional desktop or laptop computer, or even a smartwatch. The control unit 80 may be programmed and configured to wirelessly connect to the display unit 20 for controlling the visual content to be displayed on the display screen 22. The wireless connection between the display unit 20 and the control unit 80 may be accomplished through BLUETOOTH wireless technology. Other wireless technologies are also possible, such as through WIFI connection.

The display mount 10 may be made of a flexible and elastic material such as silicon rubber. The reason for making the display mount 10 is that a user of the present invention may be able to manually accommodate the display unit 20 into the display mount 10 for displaying desirable visual content, and for allowing the user to conveniently detach the display unit 20 from the display mount 10.

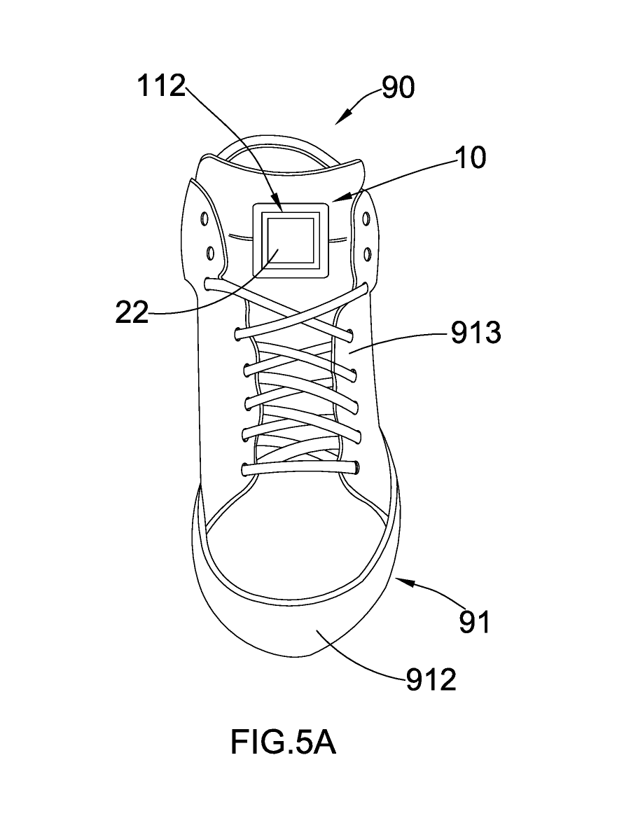

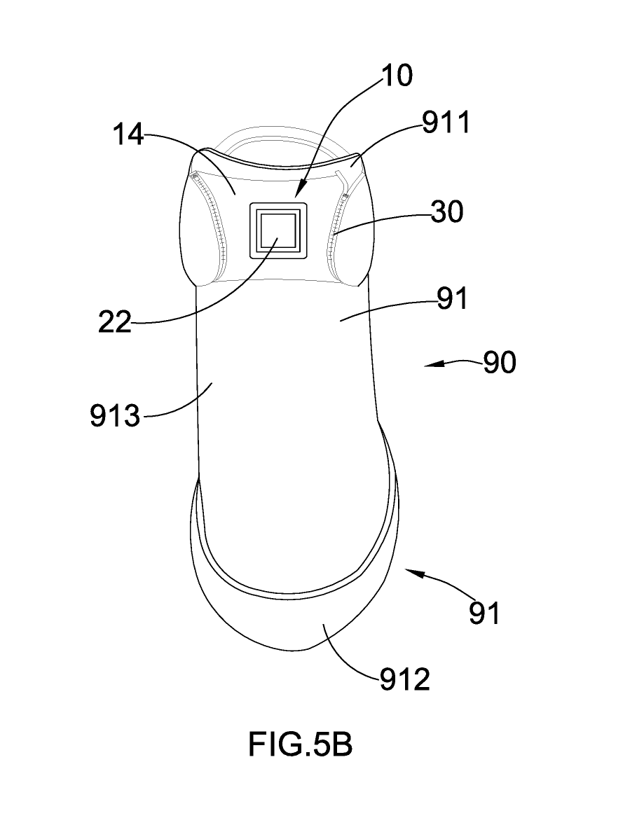

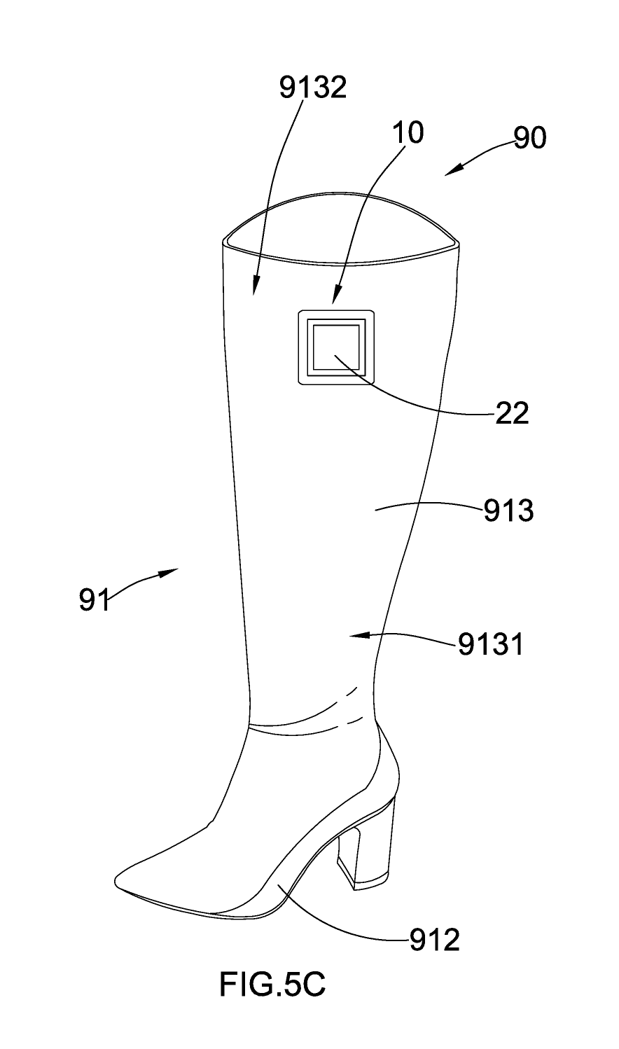

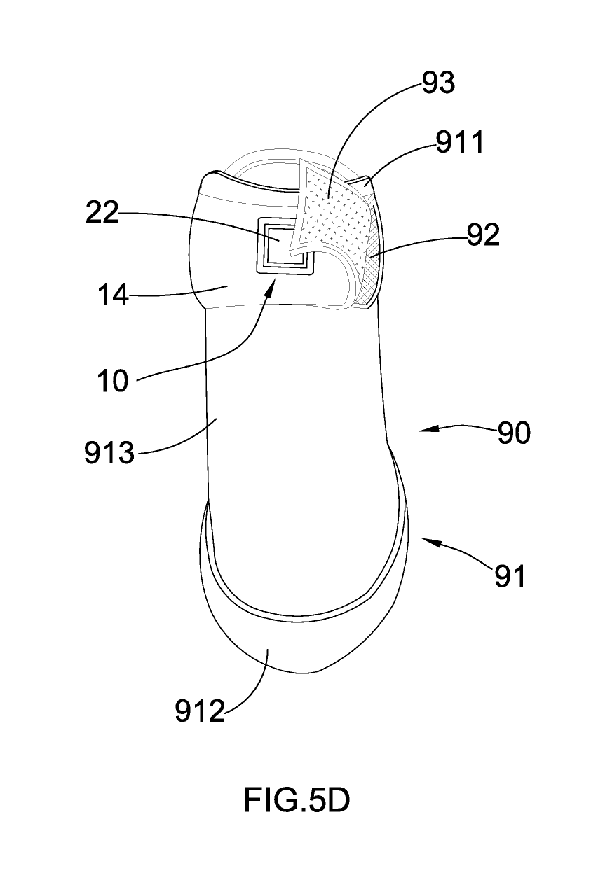

The accommodating seat 11 of the display mount 10 may be embedded in or attached on the personal accessory 90, such as a user's shoe, hat, T-shirt, pant, or other clothing. In this preferred embodiment of the present invention, the display mount 10 may be embedded in an alethic shoe as shown in FIG. 5A to FIG. 5D of the drawings. This particular example will be described in more details below.

The accommodating seat 11 may be configured to have a rectangular cross sectional shape (such as in FIG. 1 of the drawings). The accommodating seat 11 may have altogether four peripheral rims 112, wherein the peripheral rims 112 may form a boundary of the receiving cavity 111. Each of the peripheral rims 112 may have a side rim 1121 and a top securing rim 1122 extended from the side rim 1121 and partially cover the receiving cavity 111. Thus, when the main casing 21 of the display unit 20 is accommodated in the receiving cavity 111, the top securing rims 1122 may bias against the display screen 22 so as to prevent the main unit 20 from accidentally detaching from the display mount 10.

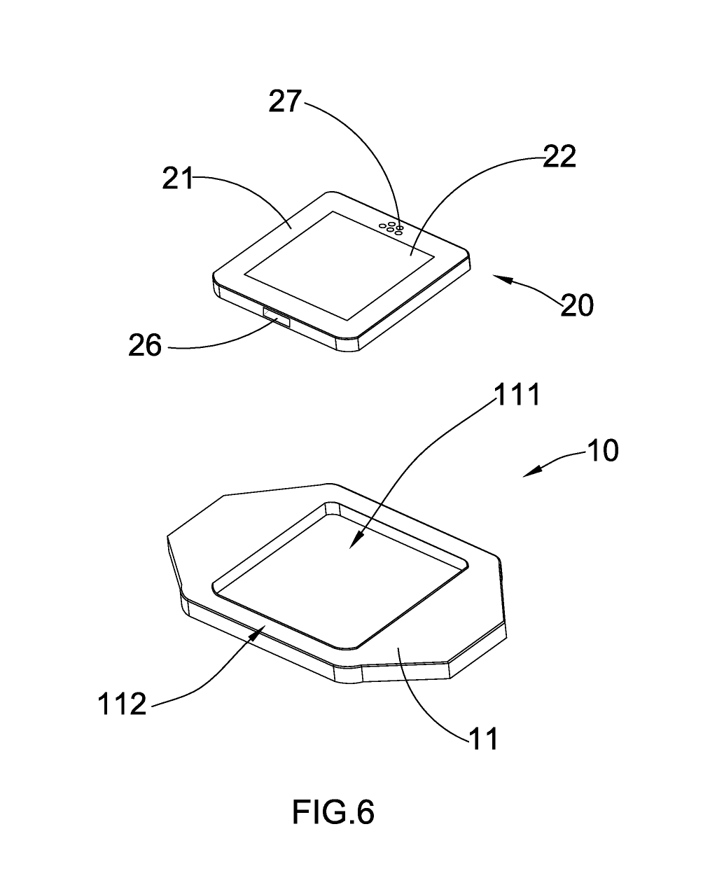

Since the accommodating seat 11 may be configured from flexible and elastic and deformable material, a user may be able to slightly deform the peripheral rims 112 so as to insert the display unit 20 to the receiving cavity 111 or to detach the display unit 20 therefrom. The accommodating seat 11 may also have other cross-sectional shapes. An exemplary shape may be illustrated in FIG. 6 of the drawings.

On the other hand, the main casing 21 of the display unit 20 may be shaped and sized to fittedly receive in the receiving cavity 111. For example, when the receiving cavity 111 of the accommodating seat 11 is rectangular in cross sectional shape, the main casing 21 may also have a rectangular cross sectional shape. The main casing 21 may be made of rigid material such as metallic material so that it may provide adequate protection to the components received in the main casing 21. It is important to mention, however, that other cross sectional shapes of the receiving cavity 111 and the main casing 21 may also be perfectly possible and should also be covered by the spirit and scope of the present invention.

The display screen 22 may be provided on the main casing 21 and may be configured as a Liquid Crystal Display (LCD) screen or a Light Emitting Diode (LED) display. The display screen 22 may be controlled and driven by the control circuitry 23 to display desirable visual content. For example, the display screen 22 may be driven to display the name of the user wearing the personal accessory 90 on which the smart displaying set is mounted. As another example, the display screen 22 may also be utilized to display the brand name (characters or stylized design) of the personal accessory 90. Since the display screen 22 is digitally controlled, it may display virtually any visual content supported by the control unit 80.

The control circuitry 23 may be implemented on a Printed Circuit Board (PCB) and may comprise a microcontroller 231 for processing information and for controlling the display screen 22 and the wireless transceiver 24. Specifically, the microcontroller 231 may be electrically connected to the display screen 22 and may be programmed to send corresponding digital signals to the display screen 22 for driving the display screen 22 to display desirable visual content.

The wireless transceiver 24 may be electrically connected to the control circuitry 23 and may be wirelessly connected to the control unit 80. The wireless transceiver 24 may comprise a BLUETOOTH module 241 for wirelessly connecting to the control unit 80 through BLUETOOTH technology. As mentioned earlier, other wireless transmission technology may also be possible. For example, the wireless transceiver 24 may be configured to enable WIFI connection so as to connect to the control unit 80 through local WIFI network or through telecommunication network, such as existing 4G LTE network.

In order to enhance the functions of the display unit 20, it may further comprise an internal data storage device 25 and at least one connection port 26 provided on the main casing 21 and electrically connected to the control circuitry 23. The internal data storage device 25 may be configured to store data in digital form. The display unit 20 may further comprise a rechargeable battery 27 electrically connected to the control circuitry 23 and/or the display screen 22, the wireless transceiver 24, and the internal data storage device 25 for providing power for the entire display unit 20. The rechargeable battery 27 may be configured as a lithium-ion battery which may be rechargeable by connecting to an external power supply, such as an external adapter or an AC power socket.

The connection port 26 may connect the control circuitry 23 to an external device such as the mobile unit 80 through a data cable or wire. It may also act as a charging port for charging the display unit 20. Thus, a user may connect the control unit 80 or an external power source to the display unit 20 through the connection port 26.

Moreover, the display unit 20 may further comprise a speaker 27 provided in the main casing 21 and electrically connected to the control circuitry 23 for delivering audible sound. The control circuitry 23 may be configured to process audio signal received from the control unit 80.

The operation of the present invention is as follows: the display mount 10 may be affixed, attached or connected to the personal accessory 90 of the user. The display unit 20 may originally be detached from the display mount 10. The user may connect the display unit 20 to the control unit 80 for the purpose of transferring data. Alternatively, the user may connect the display unit 20 to a power supply for charging thereof. The user may perform whatever necessary to maintain, synchronize, backup, transfer the data between the display unit 20 and the control unit 80 through wireless or wired connection between the display unit 20 and the control unit 80.

When the user has finished working on the display unit 20, he may simply put the display unit 20 back to the receiving cavity 111 by slightly deforming the peripheral rims 112 of the accommodating seat 11. After the user has secured the display unit 20 back to the receiving cavity 111, the display unit 20 may be secured therein by the inherent elasticity of the accommodating seat 11. Moreover, the display unit 20 may be prevented from accidentally detaching from the accommodating seat 11 by being slightly tightened by the top securing rims 1122.

It is worth mentioning that the subject matter of the present invention lies on the convenient and easy attachment and detachment of the display unit 20. The display mount 10 may be configured and embodied as having a wide variety of shapes and functions so that the display mount 10 may be connected to a wide variety of personal accessories of the user of the present invention. The following descriptions present a number of non-exhaustive variations and exemplary situations where the smart displaying set of the present invention may be employed.

As shown in FIG. 5A of the drawings, the smart displaying set may be utilized in a shoe, such as an athletic shoe as the personal accessory 90 of the user of the present invention. Thus, the personal accessory 90 may comprise a shoe 91 comprising a sole 912 and an upper member 913 provided on the sole 912, wherein the accommodating seat 11 may be embedded into an upper middle cushion layer 911 of the shoe 91. The user may insert the display unit 20 into the receiving cavity 111. The user may command the display unit 20 to display a predetermined visual display content by operating on the control unit 80 (such as his smartphone). Thus, when the display screen 22 is activated, the display screen may display predetermined visual content (such as illuminating or blinking graphics) while the user is wearing the shoe for walking or running.

The smart displaying set of the present invention may be utilized on a number of different shoes 91 and through different methods of connections. FIG. 5B illustrates that the display mount 10 may be connected to an athletic shoe through the use of two zippers 30 provided on the shoe 91. Thus, the display mount 10 may further comprise a connecting member 14 and a plurality of zippers 30 provided on two sides of the connecting member 14. The accommodating seat 11 of the display mount 10 may be connected to the connecting member 14 which may then connect to the shoe 91 through at least one (but preferably two) zippers 30. The connecting member 14 may be configured to have cushion effect so as to resemble the cushion effect of the upper middle cushion layer 911 of the shoe 91.

As shown in FIG. 5C of the drawings, the shoe 91 may be configured as a boot so that the upper member 913 may have a lower sole portion 9131 and an upper supporting portion 9132, wherein the display mount 10 and the display unit 20 may be attached on the upper supporting portion 9132 of the shoe 91.

As shown in FIG. 5D of the drawings, the display mount 10 may be attached on the shoe 91 through hoop and loop fasteners. The display mount 10 may comprise a connecting member 14. On the other hand, the shoe 91 may comprise a hoop fastener 92 while the connecting member 14 may comprise a loop fastener 93, wherein the connecting member 14 may detachably attach on the shoe 91 through the hoop fastener 92 and the loop fastener 93. Note that the position of the hoop fastener 92 and the loop fastener 93 may be reversed. The accommodating seat 11 of the display mount 10 may be provided on the connecting member 14 so that when the connecting member 14 detachably attaches on the shoe 91, the display mount 10 may be detachably attached on the shoe 91 through the use of the hoop fastener 92 and the loop fastener 93.

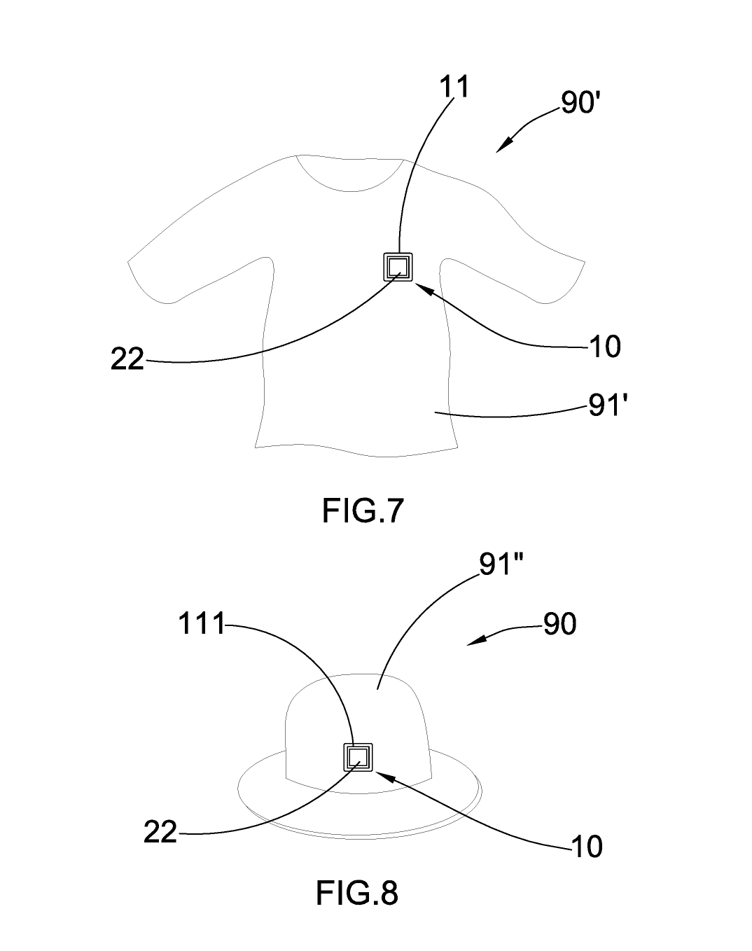

As shown in FIG. 7 of the drawings, as a first alternative mode of the present invention, the smart displaying set may be utilized in a clothing article, such as a T-shirt as the personal accessory 90′ of the user. Thus, the personal accessory 90′ may comprise a clothing article 91′ such as a T-shirt. The accommodating seat 11 may be stitched or permanently attached on a T-shirt fabric. The user may insert the display unit 20 into the receiving cavity 111. The user may command the display unit 20 to display a predetermined visual display content by operating on the control unit 80 (such as his smartphone). Thus, when the display screen 22 is activated, the display screen 22 may display predetermined visual content (such as an illuminating or blinking brand name of the T-shirt) while the user is wearing the T-shirt for causal activities.

As shown in FIG. 8 of the drawings, as a second alternative mode of the present invention, the smart displaying set may be utilized in a clothing article, such as a hat as the personal accessory 90″ of the user. Thus, the personal accessory 90″ may comprise a hat 91″. The accommodating seat 11 may be stitched or permanently attached on the hat 91″. The user may insert the display unit 20 into the receiving cavity 111. The user may command the display unit 20 to display a predetermined visual display content by operating on the control unit 80 (such as his smartphone). Thus, when the display screen 22 is activated, the display screen may display predetermined visual content (such as an illuminating or blinking brand name of the hat) while the user is wearing the hat 91″.

The present invention, while illustrated and described in terms of a preferred embodiment and several alternatives, is not limited to the particular description contained in this specification. Additional alternative or equivalent components could also be used to practice the present invention.

What is claimed is:

1. A shoe, comprising:
a sole;
an upper member provided on said sole; and
a smart displaying set for being controlled by a control unit, comprising:
a display mount which comprises an accommodating seat configured from a predetermined flexible and elastic material, said accommodating seat having a receiving cavity and a peripheral mounting rim; and
a display unit, which comprises:
a main casing sized and shaped to correspond to said receiving cavity;
a display screen supported by said main casing and visually exposed to an exterior of said display mount;
a control circuitry received in said main casing; and
a wireless transceiver received in said main casing and electrically connected to said control circuitry, said wireless transceiver being wirelessly connected to said control unit, wherein said control circuitry is arranged to drive said display screen to display customized visual content according to signals received from said control unit,
wherein said display mount is attached on said shoe, while said display unit is detachably received in said accommodating seat and secured in position by said peripheral mounting rim of said display mount, so that a user is capable of detachably attaching said display unit on said display mount and select visual content to be displayed by said display screen through controlling said control unit.

2. The shoe, as recited in claim 1, wherein said display mount is made of a flexible and elastic material so that a user is capable of manually accommodating said display unit into said display mount.

3. The shoe, as recited in claim 2, wherein said peripheral rim has a side rim and a top securing rim extended from said side rim and partially cover said receiving cavity, in such a manner that when said main casing of said display unit is accommodated in said receiving cavity, said top securing rim is arranged to bias against said display screen.

4. The shoe, as recited in claim 3, wherein said display screen is configured as a LCD screen.

5. The shoe, as recited in claim 3, wherein said display screen is configured as a LED screen.

6. The shoe, as recited in claim 5, wherein said control circuitry comprises a microcontroller for processing information and for controlling said display screen and said wireless transceiver, said microcontroller being configured to drive said display screen to display predetermined visual content.

7. The shoe, as recited in claim 6, wherein said display unit further comprise an internal data storage device and at least one connection port provided on said main casing and electrically connected to said control circuitry.

8. The shoe, as recited in claim 7, further comprising an upper middle cushion layer, said accommodating seat is embedded in said upper middle cushion layer.

9. The shoe, as recited in claim 7, wherein said display mount further comprise a connecting member and at least one zipper provided on said connecting member, said accommodating seat being connected to said connecting member which is arranged to connect to said upper member through said zipper.

10. The shoe, as recited in claim 7, wherein said wherein said display mount further comprise a connecting member having at least one of a hoop fastener and a loop fastener, said shoe further comprising a corresponding hoop fastener or a loop fastener, said connecting member may being detachably attach on said shoe through said hoop fastener and said loop fastener.

11. A smart displaying set for being controlled by a control unit, comprising:
a display mount which comprises an accommodating seat configured from a predetermined flexible and elastic material, said accommodating seat having a receiving cavity and a peripheral mounting rim; and
a display unit, which comprises:
a main casing sized and shaped to correspond to said receiving cavity;
a display screen supported by said main casing and visually exposed to an exterior of said display mount;
a control circuitry received in said main casing; and
a wireless transceiver received in said main casing and electrically connected to said control circuitry, said wireless transceiver being wirelessly connected to said control unit, wherein said control circuitry is arranged to drive said display screen to display customized visual content according to signals received from said control unit,
wherein said display mount is attached on a personal accessory, while said display unit is detachably received in said accommodating seat and secured in position by said peripheral mounting rim of said display mount, so that a user is capable of detachably attaching said display unit on said display mount and select visual content to be displayed by said display screen through controlling said control unit.

12. The smart displaying set, as recited in claim 11, wherein said display mount is made of a flexible and elastic material so that a user is capable of manually accommodating said display unit into said display mount.

13. The smart displaying set, as recited in claim 12, wherein said peripheral rim has a side rim and a top securing rim extended from said side rim and partially cover said receiving cavity, in such a manner that when said main casing of said display unit is accommodated in said receiving cavity, said top securing rim is arranged to bias against said display screen.

14. The smart displaying set, as recited in claim 13, wherein said display screen is configured as a LCD screen.

15. The smart displaying set, as recited in claim 13, wherein said display screen is configured as a LED screen.

16. The smart displaying set, as recited in claim 15, wherein said control circuitry comprises a microcontroller for processing information and for controlling said display screen and said wireless transceiver, said microcontroller being configured to drive said display screen to display predetermined visual content.

17. The smart displaying set, as recited in claim 16, wherein said wireless transceiver comprises a BLUETOOTH module for wirelessly connecting to said control unit through BLUETOOTH technology.

18. The smart displaying set, as recited in claim 17, wherein said display unit further comprise an internal data storage device and at least one connection port provided on said main casing and electrically connected to said control circuitry.

19. The smart displaying set, as recited in claim 17, wherein said display unit further comprises a rechargeable battery electrically connected to said control circuitry for providing power for said display unit.

20. The smart displaying set, as recited in claim 17, wherein said display unit further comprise a speaker provided in said main casing and electrically connected to said control circuitry for delivering audible sound.
